(19) United States
(12) Patent Application Publication
(10) Pub. No.: US 2013/0188739 A1
(43) Pub. Date: Jul. 25, 2013

(54) SYSTEMS AND METHODS FOR ENCODING, SHARING, AND DECODING OF MULTIMEDIA

(71) Applicant: OneCodec, Ltd., Aberdeen (GB)

(72) Inventors: Maja Bystrom, Belmont, MA (US); Iain E. Richardson, Aberdeen, Scotland (GB)

(73) Assignee: OneCodec, Ltd., Aberdeen (GB)

(21) Appl. No.: 13/750,638

(22) Filed: Jan. 25, 2013

Related U.S. Application Data
(60) Provisional application No. 61/590,705, filed on Jan. 25, 2012.

(51) Int. Cl. H04N 7/26

(52) U.S. Cl. CPC H04N 19/00533
USPC 375/240.25

(57) ABSTRACT

Systems and methods for encoding, sharing and decoding of multimedia data are disclosed. The systems and methods include multimedia decoding instantiation systems and multimedia processing engines which are capable of being upgraded or reconfigured to support a new or previously-unsupported compression format, without the need for platform-specific software or hardware upgrades. The systems and method further include transmission and storage of compressed data and functionality on a host device.

### CROSS REFERENCE TO RELATED APPLICATIONS

This application claims priority under 35 U.S.C. Section 119(e) to U.S. Provisional Application 61/590,705, filed on Jan. 25, 2012, entitled “SYSTEMS AND METHODS FOR ENCODING, SHARING, AND DECODING OF MULTIMEDIA,” which is assigned to the assignee hereof. The disclosure of the prior application is considered part of, and is incorporated by reference in, this application.

### BACKGROUND OF THE INVENTION

1. Field of the Invention

The present technology relates to systems and methods for encoding, sharing, and decoding multimedia data and other digital data. More particularly, the technology relates to computer architecture and operating methods that can enable users to share multimedia encoded in arbitrary formats and enable decoders to decode shared multimedia in unsupported formats.

2. Description of the Related Art

Digital multimedia capabilities can be incorporated into a wide range of devices, including digital televisions, digital direct broadcast systems, wireless communication devices such as radio telephone handsets, wireless broadcast systems, personal digital assistants (PDAs), laptop or desktop computers, digital cameras, digital recording devices, video gaming devices, video game consoles, and the like. Digital multimedia devices implement video encoding techniques or formats, such as MPEG-2, MPEG-4, or H.264/MPEG-4, Part 10, Advanced Video Coding (AVC), to transmit and receive digital multimedia more efficiently.

Multimedia data are commonly compressed/encoded prior to transmission or storage by an encoder (e.g., a server). The multimedia data are then decompressed/decoded prior to display by a decoder (e.g., mobile devices, DVD players, Blu-Ray players, TV sets, tablets, laptops, computers, set top boxes, etc). The encoder may encode the multimedia data in a particular format using a particular video encoding technique. However, the decoder may not support decoding of the format used by the encoder. For example, the format used by the encoder may be a legacy format no longer supported by decoders, or may be a new format that the decoder does not support.

Since different decoders may support different formats, traditionally multimedia needed to be coded in many different formats to support many different decoders. For example, a user downloading an multimedia file from a server through a network such as the Internet, may have many devices such as a mobile phone, a TV set, a laptop, etc. The downloaded content is traditionally in a single format. However, each of the user's devices may be configured to decode a different format. Accordingly, the user may need to download multiple versions of the multimedia data, each in a different format, for each of the decoders. This leads to bandwidth usage of the network for each version downloaded. Alternatively, the user may transcode (decode and re-encode) the multimedia data received from the downloaded format to each format required for each device. However, this requires computational resources to decode the multimedia data from the received format, and re-encode the multimedia data into the desired format. Further, this requires memory resources to store each copy of the multimedia data in each of the desired formats. Additionally, decoding and re-encoding multimedia data can lead to loss in multimedia quality as decoding and encoding processes for multimedia data are typically lossy as opposed to lossless processes.

Additionally, users of multimedia may wish to share their library with others. Currently, a user simply uploads a selected multimedia item to a remote server with sharing capabilities. The typical methods of handling multimedia formats are: (1) the user uploads the multimedia in its native format and assumes that the other users wishing to access the multimedia have the correct decoder; (2) the user converts the multimedia to a format recommended or required by the host; and, (3) the host server automatically converts the format into a pre-selected format. All of the options result in the aforementioned access or conversion loss problems; therefore a method of handling multimedia sharing including future-proofing and ensuring access is required.

### SUMMARY OF THE INVENTION

The systems, methods, and devices described herein each may have several aspects, no single one of which is solely responsible for its desirable attributes. Without limiting the scope of this disclosure as expressed by the claims which follow, its more prominent features will now be discussed briefly. After considering this discussion, and particularly after reading the section entitled “Detailed Description” one will understand how the features of this technology provide advantages that include, without being limited thereto, enabling decoders to decode unsupported multimedia formats.

One aspect of this disclosure is an multimedia processing engine. The multimedia processing engine comprises a format analyzer configured to determine the format of multimedia data. The engine also includes a functionality generator in communication with the format analyzer. The functionality generator is configured to select or generate functionality for decoding the multimedia data.

A second aspect of this disclosure is a host engine. The host engine receives the encoded multimedia and the associated data containing the decoding functionality and stores the encoded data and functionality. The host engine if further configured to serve the requested encoded data and functionality to a client.

A third aspect of this disclosure is a client user including a multimedia processing engine comprising a functionality interpreter. The client is configured to request and receive encoded data and functionality from a host server. The functionality interpreter is configured to receive data corresponding to a functionality. The functionality interpreter is further configured to generate the functionality based on the data. The engine also includes a functionality instantiator. The functionality instantiator is configured to generate a decoder based on the functionality. The decoder is configured to decode multimedia data.

Another aspect disclosed is a multimedia processing engine. The multimedia processing engine includes a format analyzer configured to determine the format of multimedia data, an encoder configured to encode the multimedia data, a functionality generator in communication with the format analyzer, the functionality generator being configured to select or generate functionality for decoding the multimedia data, and a local storage device in communication with a host device, the local storage device being configured to transmit the encoded multimedia data and decoding functionality to the host device.

In some aspects, the functionality generator selects or generates the functionality for decoding the multimedia data based on one or more parameters. In some aspects, the one or more parameters includes information regarding a storage medium. In some aspects, the information regarding a storage medium comprises at least one of: a storage capacity of the storage medium, a data access rate of the storage medium, a data storage pattern of the storage medium. In some aspects, the one or more parameters comprises information regarding a decoder. In some aspects, the information regarding a decoder comprises at least one of: a power source of the decoder, a processing capability of the decoder, a memory availability of the decoder, an available configuration time period of the decoder. In some aspects, the one or more parameters comprises information regarding a channel for transmitting the functionality. In some aspects, a functionality encoder configured to generate one or more syntax elements based on the selected functionality. In some aspects, the syntax elements include codewords. In some aspects, the multimedia processing engine also includes a multiplexer configured to multiplex the multimedia data and the syntax elements.

Another aspect disclosed is a device. The device includes a memory, and a processor coupled to the memory, the processor configured to receive and store syntax elements describing a decoder functionality and encoded multimedia transmitted from a second device, wherein the second device includes a multimedia processing engine including a decoding functionality generator; and provide the stored data to the second device or a third device in response to a user selection or action.

Another aspect disclosed is a multimedia processing engine. The multimedia processing engine includes a functionality interpreter configured to receive a bitstream indicative of a decoding algorithm, and a functionality instantiator configured to instantiate a decoder based on the bitstream, wherein the decoder is configured to decode multimedia data.

Another aspect disclosed is a system. The system includes a first device that includes a format analyzer configured to determine the format of multimedia data, an encoder configured to encode the multimedia data, a functionality generator in communication with the format analyzer, the functionality generator being configured to select or generate functionality for decoding the multimedia data, and a local storage device in communication with a second device, the local storage device being configured to transmit the encoded multimedia data and decoding functionality to the second device.

In some aspects, the second device includes a processor configured to receive and store the encoded multimedia data and decoding functionality, and, provide the stored data to the first device or a third device in response to user selection or action.

In some aspects, the third device includes a functionality interpreter configured to receive a bitstream indicative of the decoding functionality, and a functionality instantiator configured to instantiate a decoder based on the bitstream, wherein the decoder is configured to decode the encoded multimedia data.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 is a block diagram illustrating a multimedia analyzer/functionality generator that performs techniques as described in this disclosure.

FIG. 2 is a block diagram illustrating a multimedia decoder that performs techniques as described in this disclosure.

FIG. 3 is a flowchart illustrating an exemplary process for analyzing the format of multimedia data.

FIG. 4 is a flowchart illustrating an exemplary process for generating functionality for a decoder.

FIG. 5 is a flowchart illustrating an exemplary process for generating a decoder.

FIG. 6 is a block diagram illustrating a system for multimedia sharing and playback via a host server.

### DETAILED DESCRIPTION

The following detailed description is directed to certain specific embodiments. However, the teachings herein can be applied in a multitude of different ways, including for example, as defined and covered by the claims. It should be apparent that the aspects herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, a system or apparatus may be implemented or a method may be practiced using any number of the aspects set forth herein. In addition, such a system or apparatus may be implemented or such a method may be practiced using other structure, functionality, or structure and functionality in addition to or other than one or more of the aspects set forth herein. In this description, reference is made to the drawings wherein like parts are designated with like numerals throughout.

Various embodiments of systems and methods are described herein for encoding and decoding multimedia data. In the embodiments described herein, the systems and methods may allow multimedia data to be encoded and decoded in a more efficient manner. For example, the systems and methods described herein may allow for configuration of a multimedia decoder to support decoding of additional formats of multimedia data. Further, the systems and methods may allow for any type of configuration, without requiring replacement of the decoder hardware or download of new configuration data from an alternate data source other than the data provided with the multimedia data.

In one embodiment, the systems and methods described herein correspond to a reconfigurable decoder/receiver of multimedia data. The systems and methods described herein further correspond to a multimedia analyzer/functionality generator configured to determine the coding format of compressed multimedia data and generate syntax elements (e.g., codewords) for use by the decoder that are used to configure the decoder as further discussed below. It should be noted that certain embodiments described below may reference codewords, however, other syntax elements may be similarly used.

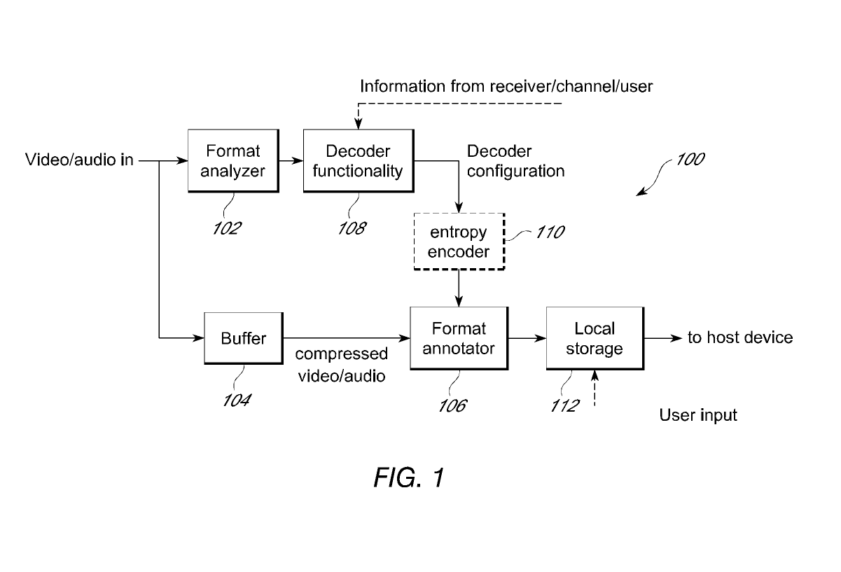

FIG. 1 is a block diagram illustrating a multimedia analyzer/functionality generator 100 that performs techniques as described in this disclosure. The multimedia analyzer/functionality generator runs on a first device. The multimedia analyzer/functionality generator 100 includes a format analyzer 102 and a first buffer 104 each configured to receive multimedia data. The first buffer 104 is in communication with a format annotator 106. The format analyzer 102 is in communication with a decoder functionality generator 108. The decoder functionality generator 108 is optionally in communication with an optional entropy encoder 110, which is further in communication with the format annotator 106. Alternatively or additionally, the decoder functionality generator 108 is directly in communication with the format annotator 106. The functionality of the components of the multimedia analyzer/functionality generator 100 is discussed in detail below.

The format analyzer 102 is configured to receive compressed multimedia data. The format analyzer 102 is configured to analyze the compressed multimedia data in order to determine the format in which the multimedia data are encoded. For example, the format analyzer 102 may compare the compressed multimedia data against structures stored in a library such as a local library (e.g., a local memory store) of the format analyzer 102 or a nonlocal library (e.g., a network storage), where different structures are associated with different formats. The structures may include, for example, file names, stream headers, formatting codes, etc. Based on the comparison to the structures, if a format with matching structures is found, the format analyzer 102 determines the format of the compressed multimedia data. If matching structures are not found, the format analyzer may determine that the multimedia data are compressed in an unknown format. One of ordinary skill in the art should recognize that the format analyzer 102 may be configured to compare and/or analyze the multimedia data to interpret a format in other manners as well. The format analyzer 102 further provides information about the detected format or a signal indicating an unknown format to the decoder functionality generator 108.

The decoder functionality generator 108 is configured to receive the information about the detected format or a signal indicating an unknown format from the format analyzer 102. If the format is known the decoder functionality generator 108 identifies one or more functionalities that are capable of decoding the detected format. The functionalities may further be stored in a local library or non-local library. The decoder functionality generator 108 may then select a particular functionality based on the identified functionalities that are capable of decoding the detected format. In one embodiment, the decoder functionality generator 108 has only one functionality to select from the library per format. In another embodiment, the decoder functionality generator 108 is configured to receive functionality from a user as an input.

In another embodiment, the decoder functionality generator 108 has multiple functionalities to select from the library per format. Different functionalities may have different features such as type of post processing of decoded data, different temporal and spatial prediction algorithms, etc. Further, different functionalities may require different complexity of the decoder. For example, some functionalities may require more or less memory for storage of code and data elements. Some functionalities may require more or less computational power to execute. Some functionalities may require more or less time for the decoder to execute. Some functionalities may require more bandwidth to transmit over a communication channel. Thus, the decoder functionality generator 108 may be configured to select or generate a functionality based on one or more parameters. The one or more parameters may include information regarding a storage medium on which the functionalities are stored such as a store capacity, a data access rate, and/or a data storage pattern of the storage medium. The one or more parameters may include information about the decoder such as a power source of the decoder, a processing capability of the decoder, a memory availability of the decoder, an available configuration time period of the decoder. The parameters may include information regarding a channel for transmitting the functionality. Accordingly, the decoder functionality generator 108 may optionally receive an input indicating information regarding one or more decoders which will eventually receive the multimedia data and/or information regarding the communication channel over which the multimedia data are to be sent. Based on this information, the decoder functionality generator 108 may select a particular functionality for decoding the determined format. For example, functionalities that require less bandwidth to transmit may be used when the information indicates that channel bandwidth is limited. Further, functionalities that require less power may be used when the information indicates the decoder is battery operated or has a fixed resolution. Further, functionalities that require less storage may be used when the information indicates the decoder has limited space, or a storage medium on which the functionality is stored has limited space. The decoder functionality generator 108 may be configured to weigh multiple points of information in selecting the functionality. The relative weights assigned to each point of information may be static or adjustable. One of ordinary skill in the art should understand similar selection processes for functionalities may be performed.

The decoder functionality generator 108 further sends information regarding the selected functionality to the optional entropy encoder 110 or directly to the format annotator 106. In one embodiment the information corresponds to syntax elements such as codewords. The decoder functionality generator 108 maps the functionality to one or more codewords with optional overhead information. The overhead information may correspond to information used by the decoder to identify and/or decode the codewords such as a header that identifies the data as codewords. In another embodiment, the mapping function is performed by a functionality encoder that is part of a separate module than the decoder functionality generator 108.

The optional entropy encoder 110 is configured to receive the codewords and optional overhead information from the decoder functionality generator 108 and to entropy encode the codewords and overhead information. Various entropy encoding configurations may be used as would be understood by one of ordinary skill in the art. The configuration information entropy encoder 110 may then transmit the entropy encoded data to the format annotator 106.

The format annotator 106 is configured to receive the compressed multimedia data from the buffer 104. The format annotator 106 is further configured to receive the codewords and optional overhead information directly from the decoder functionality generator 108, or entropy encoded codewords and optional overhead information from the entropy encoder 110. In one embodiment, the format annotator 106 is configured to act as a multiplexer. Accordingly, the format annotator 106 is configured to multiplex the codewords and optional overhead information (entropy encoded or not) with the compressed multimedia data to form a single set of bits of data or bitstream corresponding to both pieces of data. In another embodiment, the format annotator 106 keeps the compressed multimedia data and codewords and optional overhead information (entropy encoded or not) as separate sets of bits of data or bitstreams.

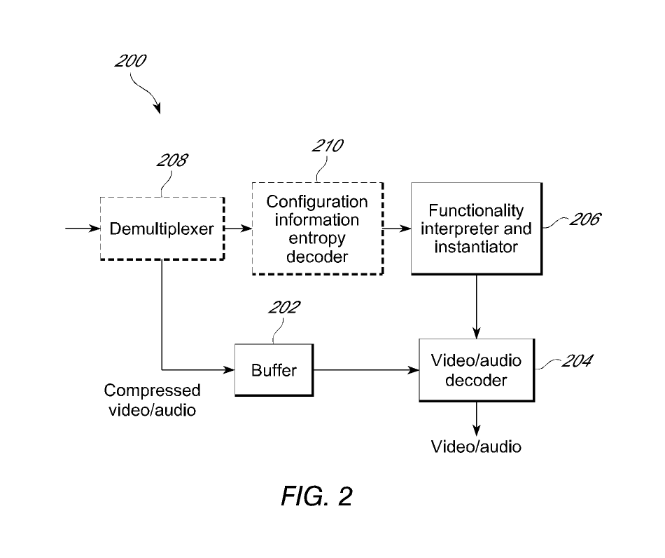

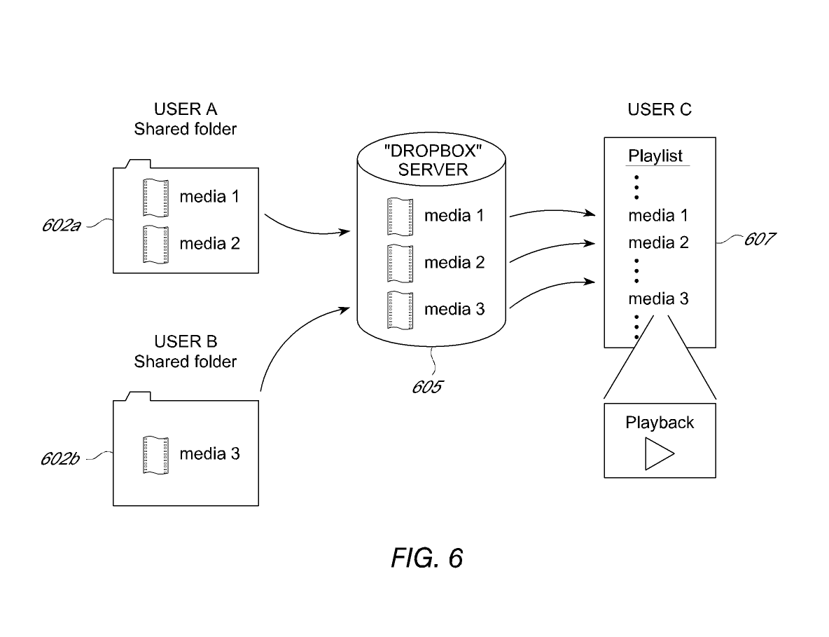

The format annotator 106 then makes the bitstream(s) available to local storage section 112. The local storage section 112 may be in communication with a host server. In one embodiment, the multimedia analyzer/functionality generator 100 may be part of a first device, and the host server may be part of a second device. In one embodiment this second device is distinct from the first device that contains the multimedia analyzer/functionality generator 100. For example, the local storage section 112 may transmit the bitstream(s) using wired or wireless transmission techniques to the host server in response to a user selection or action or at a specified time, such as system startup or synchronization. FIG. 6 is a block diagram illustrating one embodiment of a system 600 for multimedia sharing and playback via a host server. The system 600 includes two devices 602a and 602b, labeled User A and User B, that each include a multimedia analyzer/functionality generator 100 and can transmit one or more bitstream(s) to a host device 605 (e.g., a host server). Upon control or other user input the host device 60S may then transmit one or more bitstream(s) to a decoding device 607, which is labeled User C in FIG. 6. The decoding device 607 may utilize the bitstream(s) to configure a decoder to decode the compressed multimedia data as discussed in further detail below with respect to FIG. 2.

FIG. 2 is a block diagram illustrating a multimedia decoder that performs techniques as described in this disclosure. The decoder 200 includes a buffer 202 in communication with an multimedia decoder 204. The multimedia decoder 204 is further in communication with a functionality interpreter and instantiator 206. The decoder 200 optionally includes a demultiplexer 208 in communication with the buffer 202 and the functionality interpreter and instantiator 206 (directly or via a configuration information entropy decoder 210). The decoder 200 further optionally includes the configuration information entropy decoder 210 in communication with the functionality interpreter and instantiator 206. The configuration information entropy decoder 210 is further in communication with the optional demultiplexer 208, if the format annotator included in the decoder 200 creates a joint bitstream. The functionality of components of the multimedia decoder 200 is described in further detail below.

The presence or absence of optional components in the decoder 200 may be based on the configuration of components of a corresponding multimedia analyzer/functionality generator (e.g., multimedia analyzer/functionality generator 100) that sends encoded multimedia data and/or functionality to the decoder 200 for decoding. For example, if multimedia data are sent from an encoder to the decoder 200 is multiplexed as discussed above with respect to FIG. 1, the decoder may include the demultiplexer 208 to demultiplex the multiplexed data. In addition, if the data received from the encoder is entropy encoded as discussed above with respect to FIG. 1, the decoder 200 may include the entropy decoder 210 to decode the data.

The buffer 202 is configured to receive compressed multimedia data from an encoder or from the multimedia analyzer/functionality generator such as discussed above with respect to FIG. 1. The buffer 202 may receive the compressed multimedia data as a bitstream directly from the encoder or the multimedia analyzer/functionality generator. Alternatively, the multimedia analyzer/functionality generator may send a bitstream with the compressed multimedia data multiplexed with codewords and optional overhead information corresponding to functionality. Accordingly, the demultiplexer 208 receives the bitstream and demultiplexes the data into a compressed multimedia data bitstream with the compressed multimedia data and a functionality data bitstream with the codewords and optional overhead information. The demultiplexer 208 then sends the compressed multimedia data bitstream to the buffer 202. The demultiplexer 208 further sends the functionality data bitstream to the configuration information entropy decoder 210 and/or the functionality interpreter and instantiator 206.

The configuration information entropy decoder 210 is configured to entropy decode the functionality data bitstream when the data are entropy encoded by the encoder. The configuration information entropy decoder 210 is configured to send the decoded functionality data bitstream to the functionality interpreter and instantiator 206.

The functionality interpreter and instantiator 206 receives the functionality data bitstream, which includes codewords and optional overhead information, as discussed above. The functionality interpreter and instantiator 206 maps the codewords to the correct functionality. For example, the codewords may be used to map particular syntax elements to functionality such as processing elements, structures, and or code segments. Based on these syntax elements, the functionality interpreter and instantiator 206 interconnects, parameterizes, or adds to existing syntax elements used by the multimedia decoder 204. The functionality interpreter and instantiator 206 generates machine code or hardware organization and links the code or organization with the multimedia decoder 204, thus configuring the multimedia decoder 204 based on the received functionality.

The multimedia decoder 204 is configured by the functionality interpreter and instantiator 206 as discussed above. The multimedia decoder 204 further receives the multimedia data to be decompressed according to the received functionality from the buffer 202. The multimedia decoder 204 decompresses the compressed multimedia data and outputs the decoded multimedia data. The multimedia decoder 204 may comprise a field programmable gate array (FPGA) or other suitable configurable circuitry.

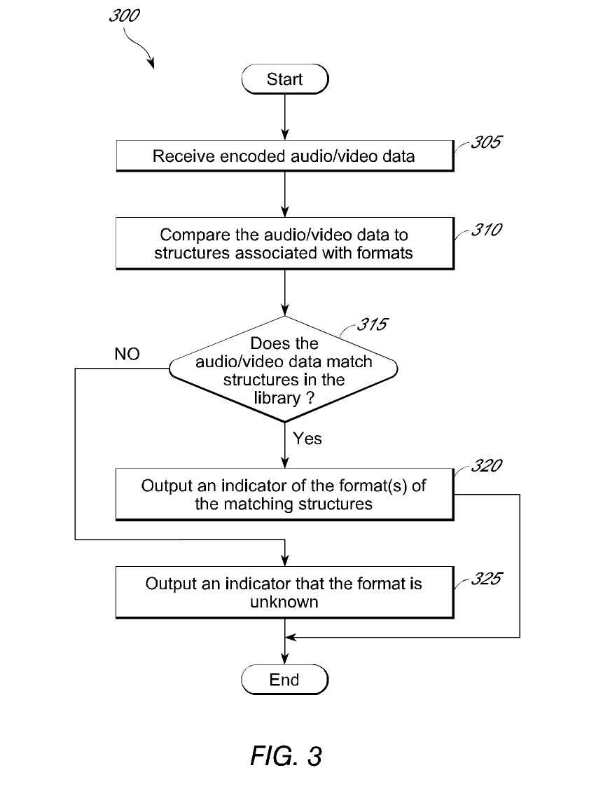

FIG. 3 is a flowchart illustrating an exemplary process 300 for analyzing the format of multimedia data. Starting at block 305, encoded multimedia data is received at an multimedia format analyzer. Continuing at block 310, the multimedia format analyzer compares the multimedia data to structures (e.g., file names, stream headers, formatting codes, etc.) associated with formats. Further at block 315, multimedia format analyzer determines whether or not the multimedia data matches structures in the library. If at block 315, the multimedia format analyzer determines the multimedia data matches structures in the library, the process continues to block 320. At block 320, the multimedia format analyzer outputs an indicator of the format(s) associated with the matching structures. If at block 315, the multimedia format analyzer determines the multimedia data does not match structures in the library, the process continues to a block 325. At block 325, the multimedia format analyzer outputs an indicator that the format of the multimedia data is unknown.

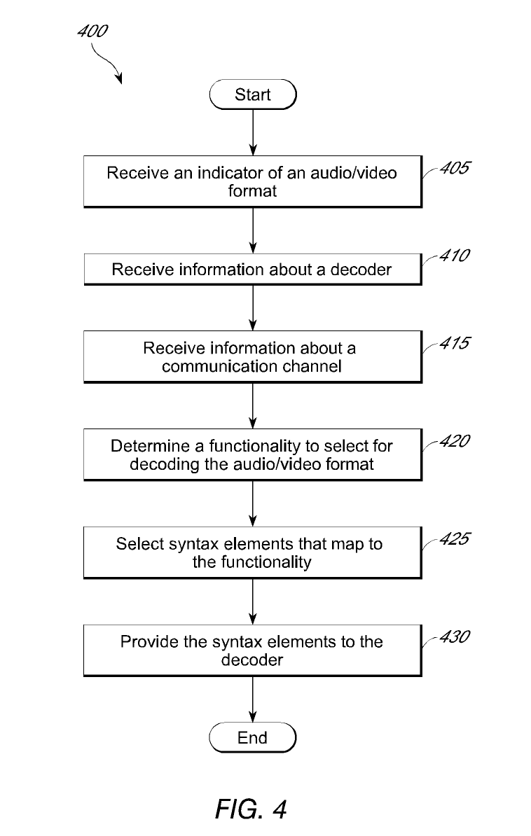

FIG. 4 is a flowchart illustrating an exemplary process 400 for generating functionality for a decoder. Starting at block 405, the multimedia decoder functionality generator receives an indicator of an multimedia format. Continuing at block 410, the multimedia decoder functionality generator optionally further receives information about a receiver/decoder. The information may include information regarding memory constraints, processor, mobility, power constraints, etc. of the decoder. Further, at block 415, the multimedia decoder functionality generator further optionally receives information about a communication channel over which functionality information is to be sent to the decoder. The information may include bandwidth limitations, load, etc. Next, at block 420, the multimedia analyzer/functionality generator determines which functionality to select for decoding multimedia data of the indicated multimedia format based on the received indicator, optional information about the decoder, and/or optional information about the communication channel. Continuing at block 425, the multimedia analyzer/functionality generator selects syntax elements such as codewords that map to the selected functionality. Further at block 430, the multimedia decoder functionality generator may provide the codewords to the decoder.

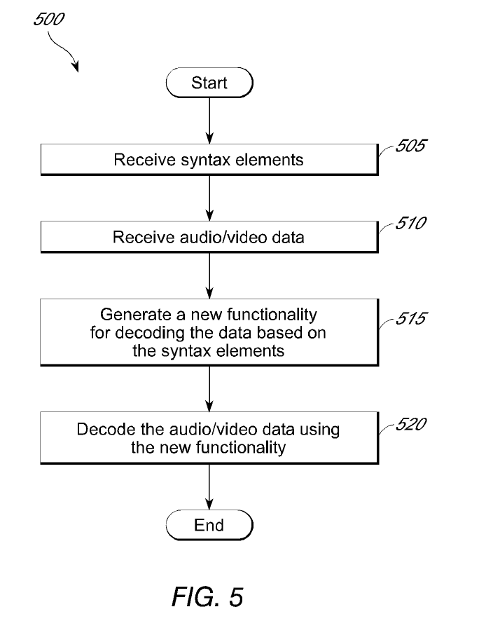

FIG. 5 is a flowchart illustrating an exemplary process 500 for generating a decoder. At block 505, the decoder receives syntax elements such as codewords. Continuing at block 510, the decoder additionally receives compressed multimedia data. Further at block 515, the decoder generates a new functionality for decoding the compressed multimedia data based on the received syntax elements. Next at block 520, the decoder decodes the multimedia data using the new functionality.

One or ordinary skill in the art should recognize that various elements or blocks may by added or omitted from the processes 300, 400, and 500. Further, the various elements of the processes 300, 400, and 500 may be performed in a different order than described above.

The technology is operational with numerous other general purpose or special purpose computing system environments or configurations. Examples of well known computing systems, environments, and/or configurations that may be suitable for use with the technology disclosed herein include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A Local Area Network (LAN), personal area network (PAN), or Wide Area Network (WAN) may be a home or corporate computing network, including access to the Internet, to which computers and computing devices comprising the system are connected. In one embodiment, the LAN conforms to the Transmission Control Protocol/Internet Protocol (TCP/IP) industry standard.

As used herein, media refers to images, graphics, sounds, video or any other multimedia type data that is entered into the system.

A microprocessor may be any conventional general purpose single- or multichip microprocessor such as a Pentium® processor, a Pentium® Pro processor, a 8051 processor, a MIPS® processor, a Power PC® processor, or an Alpha® processor. In addition, the microprocessor may be any conventional special purpose microprocessor such as a digital signal processor or a graphics processor. The microprocessor typically has conventional address lines, conventional data lines, and one or more conventional control lines.

The system is comprised of various modules/components as discussed in detail. As can be appreciated by one of ordinary skill in the art, each of the modules comprises various sub-routines, procedures, definitional statements and macros. Each of the modules are typically separately compiled and linked into a single executable program. Therefore, the description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system may be used in connection with various operating systems such as Linux®, UNIX® or Microsoft Windows®.

The system may be written in any conventional programming language such as C, C++, BASIC, Pascal, or Java, and ran under a conventional operating system. C, C++, BASIC, Pascal, Java, and FORTRAN are industry standard programming languages for which many commercial compilers can be used to create executable code. The system may also be written using interpreted languages such as Perl, Python or Ruby.

A web browser comprising a web browser user interface may be used to display information (such as textual and graphical information) to a user. The web browser may comprise any type of visual display capable of displaying information received via a network. Examples of web browsers include Microsoft's Internet Explorer browser, Netscape's Navigator browser, Mozilla's Firefox browser, PalmSource's Web Browser, Apple's Safari, or any other browsing or other application software capable of communicating with a network.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While the above description has pointed out novel features of the technology as applied to various embodiments, the skilled person will understand that various omissions, substitutions, and changes in the form and details of the device or process illustrated may be made without departing from the scope of the instant technology. Therefore, the scope of the technology is defined by the appended claims rather than by the foregoing description. All variations coming within the meaning and range of equivalency of the claims are embraced within their scope.

What is claimed is:

1. A multimedia processing engine comprising:
a format analyzer configured to determine the format of multimedia data;
an encoder configured to encode the multimedia data;
a functionality generator in communication with the format analyzer, the functionality generator being configured to select or generate functionality for decoding the multimedia data; and
a local storage device in communication with a host device, the local storage device being configured to transmit the encoded multimedia data and decoding functionality to the host device.

2. The multimedia processing engine of claim 1, wherein the functionality generator selects or generates the functionality for decoding the multimedia data based on one or more parameters.

3. The multimedia processing engine of claim 2, wherein the one or more parameters comprises information regarding a storage medium.

4. The multimedia processing engine of claim 3, wherein the information regarding a storage medium comprises at least one of: a storage capacity of the storage medium, a data access rate of the storage medium, a data storage pattern of the storage medium.

5. The multimedia processing engine of claim 2, wherein the one or more parameters comprises information regarding a decoder.

6. The multimedia processing engine of claim 5, wherein the information regarding a decoder comprises at least one of: a power source of the decoder, a processing capability of the decoder, a memory availability of the decoder, an available configuration time period of the decoder.

7. The multimedia processing engine of claim 2, wherein the one or more parameters comprises information regarding a channel for transmitting the functionality.

8. The multimedia processing engine of claim 1, further comprising a functionality encoder configured to generate one or more syntax elements based on the selected functionality.

9. The multimedia processing engine of claim 8, wherein the syntax elements comprise codewords.

10. The multimedia processing engine of claim 8, further comprising a multiplexer configured to multiplex the multimedia data and the syntax elements.

11. A device comprising:
a memory; and
a processor coupled to the memory, the processor configured to:
receive and store syntax elements describing a decoder functionality and encoded multimedia transmitted from a second device, wherein the second device includes a multimedia processing engine including a decoding functionality generator; and
provide the stored data to the second device or a third device in response to a user selection or action.

12. A multimedia processing engine comprising:
a functionality interpreter configured to receive a bitstream indicative of a decoding algorithm; and
a functionality instantiator configured to instantiate a decoder based on the bitstream, wherein the decoder is configured to decode multimedia data.

13. A system comprising:
a first device comprising:
a format analyzer configured to determine the format of multimedia data;
an encoder configured to encode the multimedia data;
a functionality generator in communication with the format analyzer, the functionality generator being configured to select or generate functionality for decoding the multimedia data; and
a local storage device in communication with a second device, the local storage device being configured to transmit the encoded multimedia data and decoding functionality to the second device.

14. The system of claim 13, wherein the second device comprises:
a processor configured to:
receive and store the encoded multimedia data and decoding functionality, and
provide the stored data to the first device or a third device in response to user selection or action.

15. The system of claim 14, wherein the third device comprises:
a functionality interpreter configured to receive a bitstream indicative of the decoding functionality; and
a functionality instantiator configured to instantiate a decoder based on the bitstream, wherein the decoder is configured to decode the encoded multimedia data.
